(19) United States
(12) Patent Application Publication
(10) Pub. No.: US 2014/0165344 A1
(43) Pub. Date: Jun. 19, 2014

(54) PROTECTIVE SHEET ASSEMBLY COUPLING MEMBER

(71) Applicant: Ed B. Perez, Granada Hills, CA (US)

(72) Inventor: Ed B. Perez, Granada Hills, CA (US)

(21) Appl. No.: 13/714,363

(22) Filed: Dec. 13, 2012

(51) Int. Cl. B32B 3/06; A44B 17/00

(52) U.S. Cl. CPC B32B 3/06; A44B 17/00
USPC 24/591.1; 428/411.1; 428/221; 428/99

(57) ABSTRACT

A coupling member for a sheet assembly. The coupling member includes a top portion and a bottom portion spaced from the top portion. A gap exists between the top and bottom portions. The gap is capable of receiving a portion of the sheet assembly therein. Also, at least one fastener is coupled to at least one of the top and bottom portions.

### CROSS REFERENCE TO RELATED APPLICATIONS

This application is a continuation of U.S. application Ser. No. 12/720,374 filed Mar. 10, 2010, entitled “PROTECTIVE SHEET ASSEMBLY.”

### BACKGROUND OF INVENTION

This application relates generally to protective devices. More specifically, this application relates to protective sheet assemblies.

### SUMMARY

Items are frequently protected by textile sheets or rubber sheets. While these sheets are generally effective in protecting items from rain, snow and the like, these sheets do not insulate the items from exterior temperatures. Therefore, there exists a significant need for a protective sheet assembly capable of protecting and insulating items or users from precipitation as well as insulate items or users from exterior temperatures.

This application discloses a coupling member for a sheet assembly, the coupling member comprising: a top portion; a bottom portion spaced from the top portion such that a gap exists between the top and bottom portions, the gap capable of receiving a portion of the sheet assembly therein; and at least one fastener coupled to at least one of the top and bottom portions.

This application further discloses a protective sheet assembly comprising: a sheet member comprising: a first layer, the first layer comprising a breathable material; and a second layer coupled to the first layer, the second layer comprising a reflective member; and a coupling member secured to the sheet member, the coupling member comprising a top portion; a bottom portion spaced from the top portion, wherein the sheet member is disposed between the top and bottom portions; and at least one fastener coupled to at least one of the top and bottom portions.

This application also discloses a protective sheet assembly comprising: a sheet member; and a coupling member secured to the sheet member, the coupling member comprising: a top portion; a bottom portion spaced from the top portion, wherein the sheet member is disposed within the gap; and at least one fastener coupled to at least one of the top and bottom portions.

### BRIEF DESCRIPTION OF THE DRAWINGS

The drawings, when considered in connection with the following description, are presented for the purpose of facilitating an understanding of the subject matter sought to be protected.

FIG. 1 is a top plan view of an illustrative protective sheet assembly;

FIG. 2 is a cross-sectional side view of the illustrative protective sheet assembly taken along line 2-2 in FIG. 1;

FIG. 3 is a top plan view of an illustrative coupling member;

FIG. 4 is a side view of the coupling member of FIG. 3;

FIG. 5 is a partial environmental side view of an illustrative protective sheet assembly;

FIG. 6 is a partial environmental side view of an illustrative protective sheet assembly;

FIG. 7 is a partial environmental side view of an illustrative protective sheet assembly; and

FIG. 8 is a partial environmental side view of an illustrative protective sheet assembly.

### DETAILED DESCRIPTION

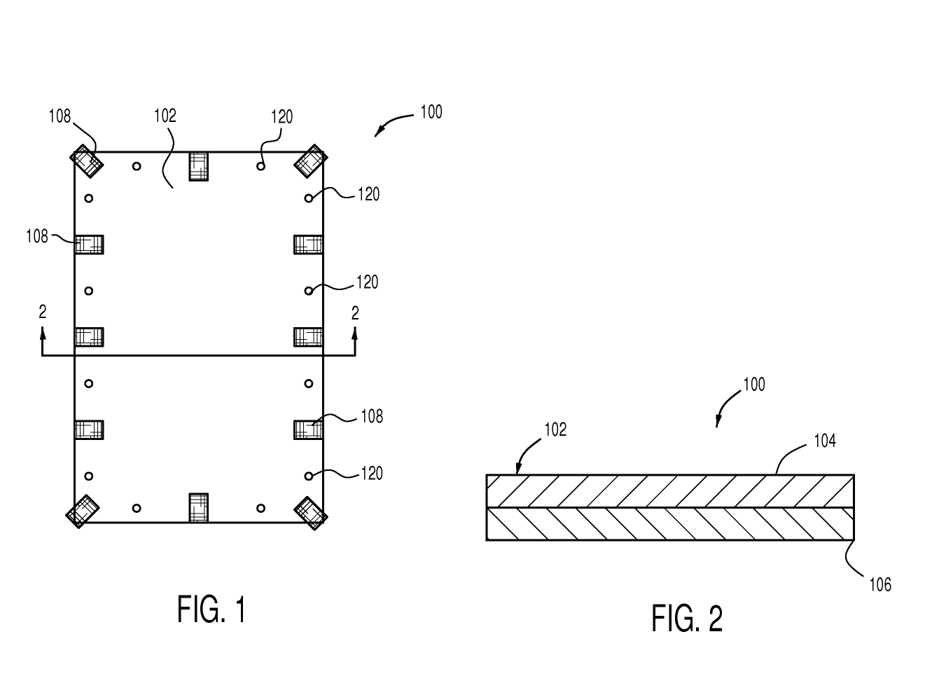

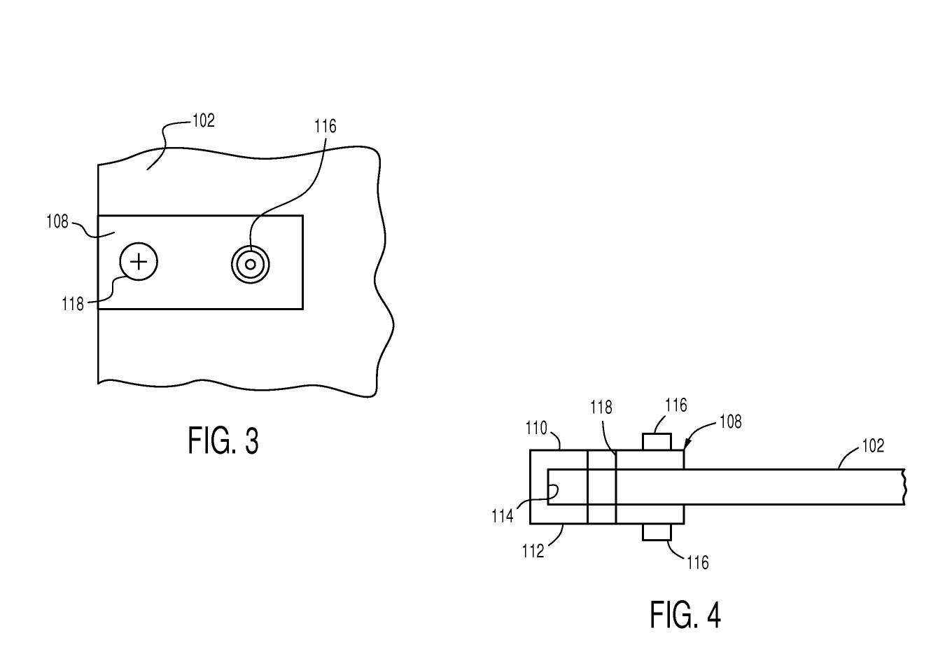

Referring now to FIGS. 1-8, an illustrative protective sheet assembly 100 is shown. The sheet assembly 100 generally includes a sheet member 102, at least one coupling member 108, and at least one fastener member 120. The sheet member 102 may be formed as having at least a first layer 104 and a second layer 106. The first layer 104 is formed from a breathable material. In one embodiment, the breathable material is a nylon. In another embodiment, the breathable material is a 70D textured ripstop nylon. However, it will be appreciated that any suitable breathable material may be employed and remain within the scope of the present disclosure.

The second layer 106 may include an ultra-violet and/or thermal reflective material. In one embodiment, the second layer 106 includes a metallic sheet material laminated to at least one of a polymeric and/or textile sheet. In one embodiment, the metallic sheet material is aluminum; however, it will be appreciated that any suitable metallic material may be employed and remain within the scope of the present disclosure. The polymeric and/or textile sheet may be any suitable material for laminating a metallic sheet to so as to provide a ultra-violet and/or thermal reflective sheet. In one embodiment, the metallic sheet is laminated to a nylon sheet. In one embodiment, the metallic sheet is laminated to a 70D textured ripstop nylon. However, it will be appreciated that the second layer 106 may be formed from any suitable ultra-violet and/or thermal reflective material and/or combination and remain within the scope of the present disclosure. The second layer 106 may be coupled to the first layer 104 via any suitable device or means. In one embodiment, the second layer 106 is stitched to the first layer 104. However, it will be appreciated that the first layer 104 and second layer 106 may be coupled together via any suitable means or device and remain within the scope of the present disclosure. Illustrative coupling devices and/or means include, but are not limited to, bonding, adhesive, mechanical fastener, sonic welding, or any other suitable coupling means.

The sheet assembly 100 may be arranged relative to a user or item to either prevent ultra-violet radiation and/or thermal energy from reaching the user or item so as to keep the user or item relatively cool or prevent ultra-violet radiation and/or thermal energy from escaping from the proximity of the user or item so as to keep the user or item relatively warm. For example, in order to keep a user or item relatively cool, the sheet assembly 100 may be arranged such that the second layer 106 is adjacent to the user or item and first layer 104 is facing away from the user or item. In order to keep a user or item relatively warm, the sheet assembly 100 may be arranged such that the first layer 104 is adjacent to the user or item and the second layer 106 is facing away from the user or item.

The coupling member 108 is configured to coupled the sheet assembly 100 to one or more adjacent sheet assemblies and/or other device(s) or structure(s). The illustrative coupling member 108 includes a top portion 110 and a bottom portion 112. In one embodiment, the sheet member 102 is disposed between the coupling member top portion 110 and coupling member bottom portion 112. In one embodiment, the coupling member is disposed about the edge 114 of the sheet member 102; however, it will be appreciated that the coupling member 110 may be disposed about any portion of the sheet member 102 and remain within the scope of the present disclosure. As will be discussed further below, the coupling member 110 may include one or more fasteners 116 for mateably engaging another fastener 116 or fastener member 120 of the sheet assembly or of an adjacent sheet assembly or any other suitable structure or device. The fastener 116 may be any suitable fastening device capable of releasably engaging, or mateably engaging, an adjacent fastener 116 or fastener member 120. In one embodiment, the fastener is a gypsy fastener; however, it will be appreciated that any other fastener type may be employed and remain within the scope of the present disclosure. The coupling member 108 may also include one or more apertures 118 adapted to receive a portion of a support structure 122. While the illustrative support structure 122 is a rod-shaped device, it will be appreciated that the support structure may be any suitable device or assembly and remain within the scope of the present disclosure.

The sheet assembly 100 may also include a fastener member 120. The fastener member 120 may be configured to releasably engage, or mateably engage, an adjacent fastener member 120 or adjacent coupling member fastener 116 of the sheet assembly 100, of one or more adjacent sheet assemblies and/or any other device(s) or structure(s). The fastener member 120 may be any suitable fastening device capable of releasably engaging, or mateably engaging, an adjacent fastener 116 or fastener member 120. In one embodiment, the fastener is a gypsy fastener; however, it will be appreciated that any other fastener type may be employed and remain within the scope of the present disclosure.

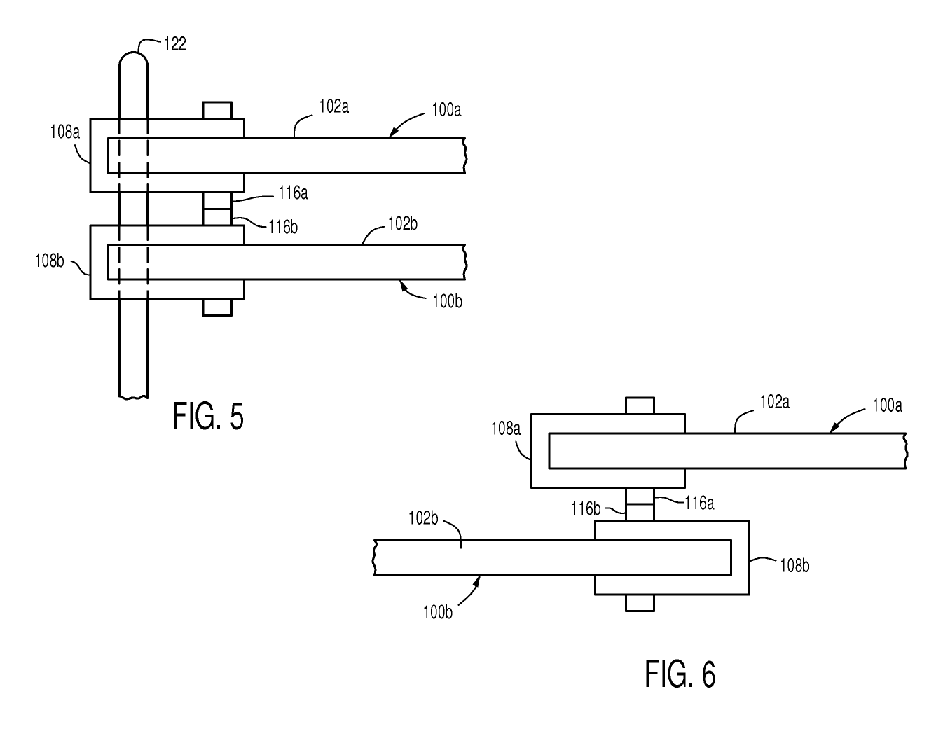

In one embodiment, two or more sheet assemblies may be used as modular components for constructing any suitable protective structure. With particular reference to FIGS. 5 and 6, a first sheet assembly 100a may be releasably coupled to a second sheet assembly 100b wherein a fastener 116a of the coupling member 108a of the first sheet assembly 100a may releasably engage a fastener 116b of the coupling member 108b of the second sheet assembly 100b. As shown in FIG. 5, the sheet member 100a of the first sheet assembly 100a may be substantially parallel with the sheet member 100b of the second sheet assembly 100b. Alternatively, as shown in FIG. 6, the sheet member 100a of the first sheet assembly 100a may be adjacent to the sheet member 100b of the second sheet assembly 100b. It will be appreciated that the sheet assemblies 100a, 100b may be arranged at any suitable relationship relative to one another and remain within the scope of the present disclosure. Also, while the sheet assemblies of FIG. 5 are shown engaged with a support structure 122, it will be appreciated that sheet assemblies 100a, 100b not so engaged remain within the scope of the present disclosure.

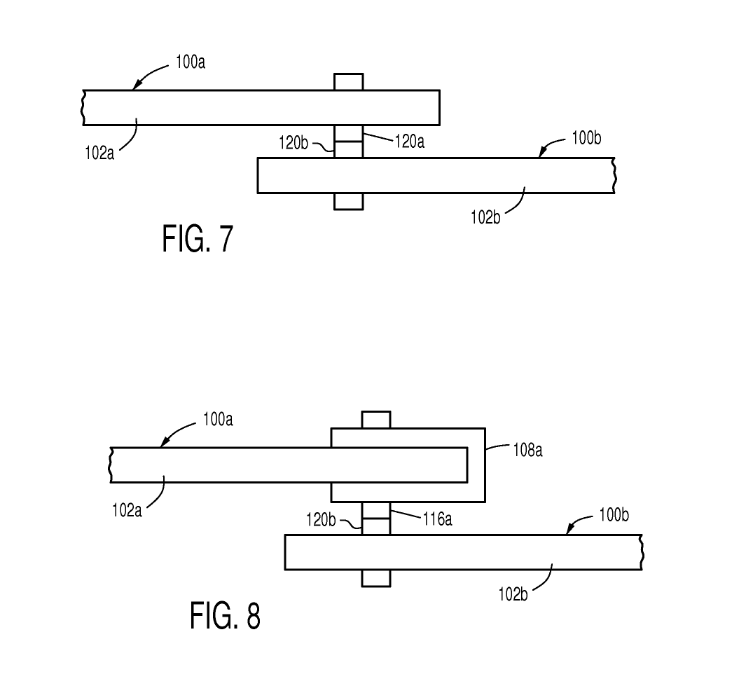

Referring now to FIG. 7, a first sheet assembly 100a and second sheet assembly 100b may be coupled, at least in part, by engaging a fastener member 120a of the first sheet assembly 100a with a fastener member 120b of the second sheet assembly 100b. As shown in FIG. 7, the sheet members 102a, 102b may be adjacent to one another. In an alternative embodiment, the sheet members 102a, 102b may be substantially parallel. It will be appreciated that the sheet assemblies 100a, 100b may be arranged at any suitable relationship relative to one another and remain within the scope of the present disclosure.

Referring now to FIG. 8, a first sheet assembly 100a and second sheet assembly 100b may be coupled, at least in part, by engaging a fastener 116a of the coupling member 108a of the first sheet assembly 100a with a fastener member 120b of the second sheet assembly 100b. As shown in FIG. 8, the sheet members 102a, 102b may be adjacent to one another. In an alternative embodiment, the sheet members 102a, 102b may be substantially parallel. It will be appreciated that the sheet assemblies 100a, 100b may be arranged at any suitable relationship relative to one another and remain within the scope of the present disclosure. Also, while the illustrative embodiments of FIGS. 5-8 show only two sheet assemblies 100a, 100b, it will be appreciated that any suitable number of sheet assemblies may be employed and remain within the scope of the present disclosure.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A protective sheet assembly comprising:
a sheet member comprising:
a first layer, the first layer comprising a breathable material; and
a second layer coupled to the first layer, the second layer comprising a reflective member.

2. The protective sheet assembly of claim 1 wherein the breathable material is a nylon.

3. The protective sheet assembly of claim 2 wherein the nylon is 70D textured ripstop nylon.

4. The protective sheet assembly of claim 1 wherein the reflective member comprises a metal sheet material laminated to at least one of a polymeric sheet and textile sheet.

5. The protective sheet assembly of claim 4 wherein the metal sheet material is aluminum.

6. The protective sheet assembly of claim 4 wherein the metal sheet is laminated to a nylon sheet

7. The protective sheet assembly of claim 1 wherein the first layer is stitched to the second layer.

8. The protective sheet assembly of claim 1 further comprising at least one coupling member.

9. The protective sheet assembly of claim 9 wherein the coupling member comprises a top portion and a bottom portion, wherein the sheet member is disposed between the coupling member top portion and coupling member bottom portion

10. The protective sheet assembly of claim 9 wherein the coupling member comprises at least one fastener.

11. A protective sheet assembly comprising:
a sheet member comprising:
a first layer, the first layer comprising a breathable material; and
a second layer coupled to the first layer, the second layer comprising a reflective member; and
a coupling member secured to the sheet member, the coupling member comprising:
a top portion;
a bottom portion spaced from the top portion, wherein the sheet member is disposed between the top and bottom portions; and
at least one fastener coupled to at least one of the top and bottom portions.

12. The protective sheet assembly of claim 11 further comprising an aperture extending through the coupling member and sheet member.

13. The protective sheet assembly of claim 11 wherein the fastener is a gypsy fastener.

14. The protective sheet assembly of claim 11 wherein the fastener is adapted for releasably coupling to an fastener of an adjacent coupling member.

15. The protective sheet assembly of claim 14 wherein the adjacent coupling member is secured to an adjacent sheet assembly.

16. A protective sheet assembly comprising:
a sheet member; and
a coupling member secured to the sheet member, the coupling member comprising:
a top portion;
a bottom portion spaced from the top portion, wherein the sheet member is disposed within the gap; and
at least one fastener coupled to at least one of the top and bottom portions.

17. The protective sheet assembly of claim 16 further comprising an aperture extending through the sheet member and coupling member.

18. The protective sheet assembly of claim 16 wherein the fastener is a gypsy fastener.

19. The protective sheet assembly of claim 16 wherein the fastener is adapted for releasably coupling to a fastener of an adjacent coupling member.

20. The protective sheet assembly of claim 19 wherein the adjacent coupling member is secured to an adjacent sheet assembly.
